(19) United States
(12) Patent Application Publication
(10) Pub. No.: US 2016/0109997 A1
(43) Pub. Date: Apr. 21, 2016

(54) TOUCH SUBSTRATE AND MANUFACTURING METHOD THEREOF, TOUCH DISPLAY PANEL

(71) Applicants: BOE TECHNOLOGY GROUP CO., LTD., Beijing (CN); Chongqing BOE Optoelectronics Technology Co., Ltd., Chongqing (CN)

(72) Inventors: Daoping YU, Beijing (CN); Gyuhyun LEE, Beijing (CN); Fujun LIU, Beijing (CN); Qichao CHEN, Beijing (CN)

(21) Appl. No.: 14/804,014

(22) Filed: Jul. 20, 2015

(30) Foreign Application Priority Data
Oct. 15, 2014 (CN) 201410544991.X

(51) Int. Cl. G06F 3/041

(52) U.S. Cl. CPC G06F 3/0412; G06F 2203/04103

(57) ABSTRACT

Embodiments of the present invention provide a touch substrate, a manufacturing method thereof and a touch display panel to solve the problem in the prior art that leads connected with a touch unit excessively occupy the peripheral area of an active area. According to the touch substrate, the manufacturing method thereof and the touch display panel provided by embodiments of the present invention, the peripheral area of the active area occupied by the leads is reduced as the first or second leads are provided within the active area, so that the design of narrow bezel for touch screen can be achieved.

### FIELD OF THE INVENTION

The present invention relates to the field of display technology, and particularly relates to a touch substrate, a manufacturing method of the touch substrate, and a touch display panel.

### BACKGROUND OF THE INVENTION

As a novel input device, touch screen is a simple, convenient and natural interactive manner, and has been widely used.

The main device for realizing touch function is a touch unit. As shown in FIG. 1, the touch unit generally includes a plurality of first touch sub-units 2 and a plurality of second touch sub-units 3 provided within an active area 1. The first touch sub-unit 2 includes a plurality of touch electrode patterns extending in X direction, and the second touch sub-unit 3 includes a plurality of touch electrode patterns extending in Y direction, wherein the X direction is perpendicular to the Y direction. Between the first touch sub-units 2 and the second touch sub-units 3, a dielectric layer is provided, so that the first touch sub-units 2 are insulated from the second touch sub-units 3. By respectively calculating signals from the first touch sub-units 2 and signals from the second touch sub-units 3, user's touch positions can be determined.

The first touch sub-units 2 and the second touch sub-units 3 are electrically connected to an integrated circuit board through first leads 21 and second leads 31, respectively, so as to transmit signals. In the prior art, the first leads 21 and the second leads 31 are generally provided at the peripheral area of the active area 1, and are then aggregated to one side of the active area 1 by folding, e.g., aggregated below the active area 1, as shown in FIG. 1. The first leads 21 and the second leads 31 are arranged on the same layer. The arrangement mode of the first leads 21 and the second leads 31 occupies the peripheral area of the active area 1, so that width of bezel of the touch screen cannot be reduced to the greatest extent, which adversely affects design of narrow bezel for the touch screen.

### SUMMARY OF THE INVENTION

In view of the above problems, embodiments of the present invention provide a touch substrate suitable for design of narrow bezel for touch screen, a manufacturing method of the touch substrate and a touch display panel.

According to an embodiment of the present invention, there is provided a touch substrate, including a touch unit, which includes a plurality of first touch sub-units and a plurality of second touch sub-units both provided within an active area, wherein

the plurality of first touch sub-units and the plurality of second touch sub-units are electrically connected to a bonding area located outside the active area, through a plurality of first leads and a plurality of second leads, respectively; and

the plurality of first leads or the plurality of second leads are provided within the active area.

The plurality of the second touch sub-units may be a plurality of longitudinal touch sub-units, and the plurality of longitudinal touch sub-units are respectively connected to the plurality of second leads provided at the same side thereof; and

the plurality of the first touch sub-units may be a plurality of transverse touch sub-units, and the plurality of transverse touch sub-units are respectively connected to the plurality of first leads within the active area through via holes.

Positions of via holes for any two adjacent transverse touch sub-units correspond to ends of the two adjacent transverse touch sub-units at different sides.

An insulating layer may be provided between the first leads and the touch unit.

The via holes may be provided in the insulating layer.

The insulating layer may be made of silicon dioxide, silicon nitride, silicon oxynitride, or a transparent and insulating resin.

The first or second leads provided within the active area may be made of a transparent and conductive material.

The first or second leads provided within the active area may be made of indium tin oxide.

The first or second leads provided within the active area may be of a transparent composite structure having an anti-reflective coating.

According to an embodiment of the present invention, there is further provided a manufacturing method of the above touch substrate, including steps of:

forming a plurality of second touch sub-units and a plurality of second leads located at the same side of the respective second touch sub-units on a base through a patterning process;

forming a first insulating layer;

forming a plurality of first touch sub-units on the first insulating layer through a patterning process;

forming a second insulating layer;

forming a plurality of via holes in the second insulating layer through a patterning process; and

forming a plurality of first leads within an active area, the plurality of first leads being respectively connected with the plurality of first touch sub-units through the plurality of via holes.

According to an embodiment of the present invention, there is further provided a touch display panel, including the above touch substrate.

According to the touch substrate, the manufacturing method thereof and the touch display panel, the peripheral area of the active area occupied by the leads is reduced as the first or second leads are provided within the active area, so that the design of narrow bezel for the touch screen can be achieved.

### BRIEF DESCRIPTION OF THE DRAWINGS

FIG. 1 is a top view of a structure of a touch substrate in the prior art;

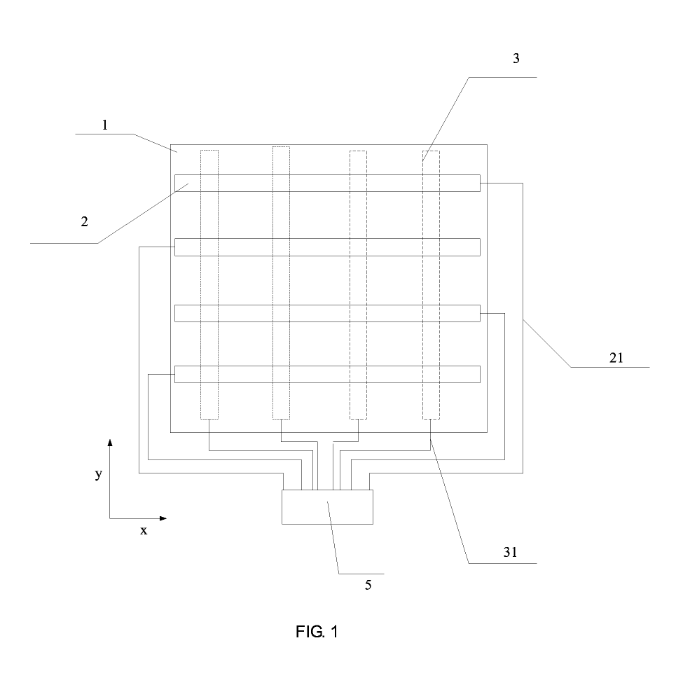

FIG. 2 is a top view of a structure of a touch substrate in Embodiment 1 of the present invention;

FIG. 3 is a top view of a structure of a touch substrate after longitudinal touch sub-units and second leads have been formed in Embodiment 2 of the present invention;

FIG. 4 is a top view of the structure of the touch substrate after transverse touch sub-units have been formed in Embodiment 2 of the present invention;

FIG. 5 is a top view of the structure of the touch substrate after via holes have been formed in Embodiment 2 of the present invention; and

FIG. 6 is a top view of the structure of the touch substrate after first leads have been formed in Embodiment 2 of the present invention.

### DETAILED DESCRIPTION OF THE EMBODIMENTS

To make those skilled in the art better understand the technical solutions of the present invention, the present invention will be further described in details below in conjunction with the accompany drawings and specific implementations.

### Embodiment 1

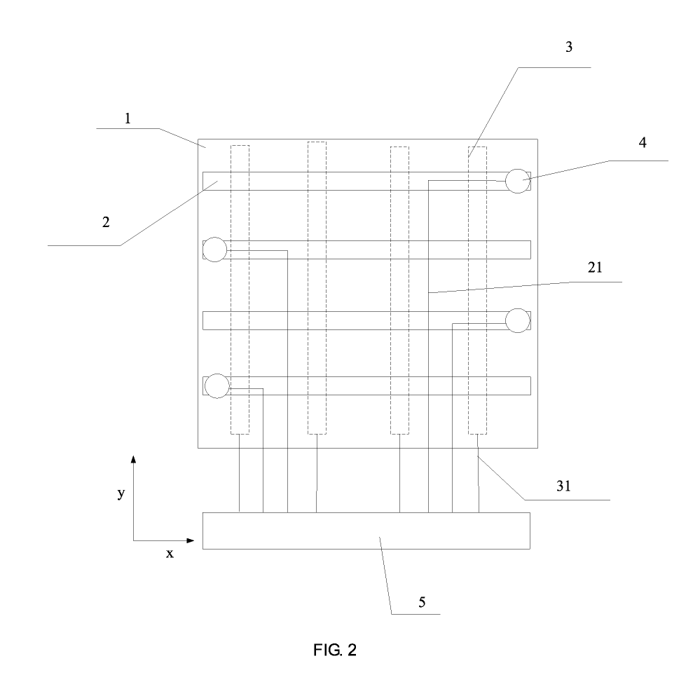

As shown in FIG. 2, this embodiment provides a touch substrate, including a touch unit. The touch unit includes a plurality of first touch sub-units 2 and a plurality of second touch sub-units 3 within an active area 1.

The plurality of first touch sub-units 2 and the plurality of second touch sub-units 3 are electrically connected to a bonding area 5 located outside the active area 1, through a plurality of first leads 21 and a plurality of second leads 31, respectively. The first leads 21 are provided within the active area 1.

In the touch substrate of the present embodiment, the peripheral area of the active area 1 occupied by the leads is reduced as the first leads 21 are provided within the active area 1. Therefore, the problem in the prior art that the design of narrow bezel for touch screen can be hardly achieved, caused by providing the first leads 21 and the second leads 31 at the periphery of the active area 1, can be prevented.

It should be understood that, in this embodiment, the shape of the first touch sub-unit and the second touch sub-unit is strip, but the touch sub-unit having other shape such as rhombus, modified rhombus and the like may also be employed.

Specifically, as shown in FIG. 2, the second touch sub-units 3 are longitudinal touch sub-units, and the longitudinal touch sub-units are connected to the bonding area 5, which is located below the active area 1, through the plurality of second leads 31 located at their same side (i.e., side close to the bonding area 5) of the second touch sub-units, respectively.

The first touch sub-units 2 are transverse touch sub-units, and the transverse touch sub-units are connected to the bonding area 5, which is located below the active area 1, through the plurality of first leads 21 within the active area 1, and the plurality of first leads 21 are connected to the transverse touch sub-units through via holes 4, respectively.

To distribute the first leads 21 uniformly within the active area 1 and to insulate the first leads 21 from each other, each of the first leads 21 may include two portions connected with each other, wherein the first portion is connected to the via hole 4 and is parallel to the transverse touch sub-unit, and the second portion is parallel to the longitudinal touch sub-unit and is connected to the bonding area 4 located below the active area 1. In addition, the second portions of the plurality of first leads 21 may be equidistantly arranged by appropriately setting the lengths of the first portions of the plurality of first leads 21.

In this embodiment, the second leads 31 directly lead out from the lower side of the active area 1, and the first leads 31 are provided within the active area 1 and lead out from the lower side of the active area 1. Therefore, the peripheral areas at two sides (left and right sides in figure) of the active area 1 are not occupied, and it is advantageous for the design of narrow bezel.

Preferably, positions of the via holes for any two adjacent transverse touch sub-units correspond to ends of the two adjacent transverse touch sub-units at different sides. It should be understood that the via holes 4 may be arranged in other manners, e.g., all arranged corresponding to the ends at the same side or central positions of the transverse touch sub-units, as long as the first leads 21 can be connected to the transverse touch sub-units through the via holes 4.

Preferably, a function layer including the first leads 21 is insulated from the touch unit, so as to avoid impacts on signal transmission.

Specifically, an insulating layer may be provided between the first leads 21 and the touch unit, and the via holes 4 may be provided in the insulating layer. Preferably, the insulating layer may be made of silicon dioxide, silicon nitride, silicon oxynitride or a transparent and insulating resin. It should be understood that other transparent resin with high resistance may also be suitable.

Preferably, the first leads 21 may be made of a transparent and conductive material. Preferably, the first leads 21 may be made of indium tin oxide.

It should be understood that the first leads 21 may be of a transparent composite structure having an anti-reflective coating.

### Embodiment 2

The present embodiment provides a manufacturing method of a touch substrate, including the following steps of S1 to S6.

S1, forming a plurality of second touch sub-units 3 and a plurality of second leads 31 located at the same side of the respective second touch sub-units 3 on a base through a patterning process.

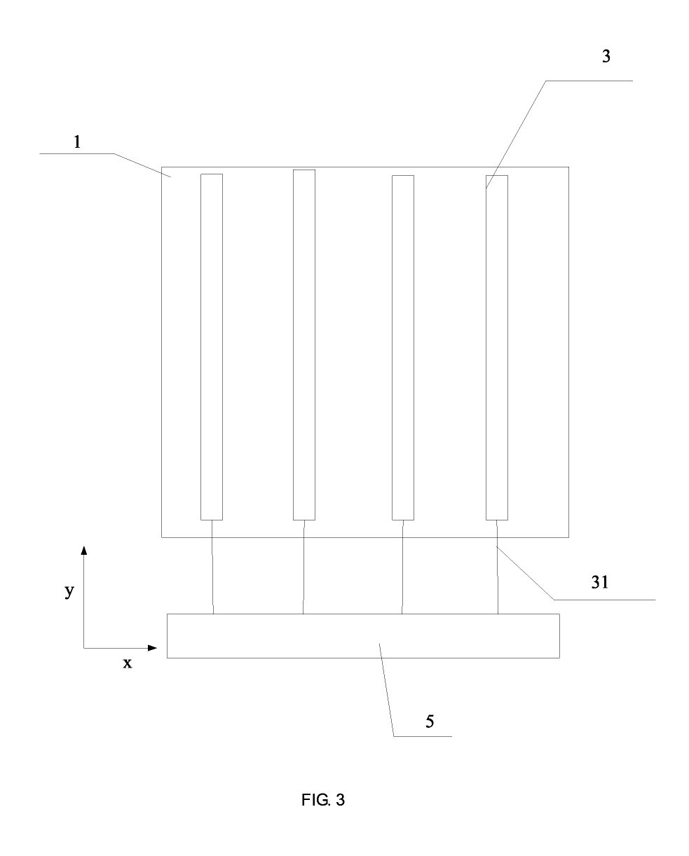

Specifically, as shown in FIG. 3, the second touch sub-units 3 may be longitudinal touch sub-units. The plurality of longitudinal touch sub-units and the plurality of second leads 31 located at the same side of the respective longitudinal touch sub-units are integrally formed through a patterning process using a mask. The second leads 31 are connected to a bonding area 5.

S2, forming a first insulating layer.

Specifically, the first insulating layer may be formed by depositing silicon dioxide, silicon nitride, or silicon oxynitride, or by coating a transparent and insulating resin. Specifically, plasma vapor deposition or physical sputtering deposition may be employed.

S3, forming a plurality of first touch sub-units 2 on the first insulating layer through a patterning process.

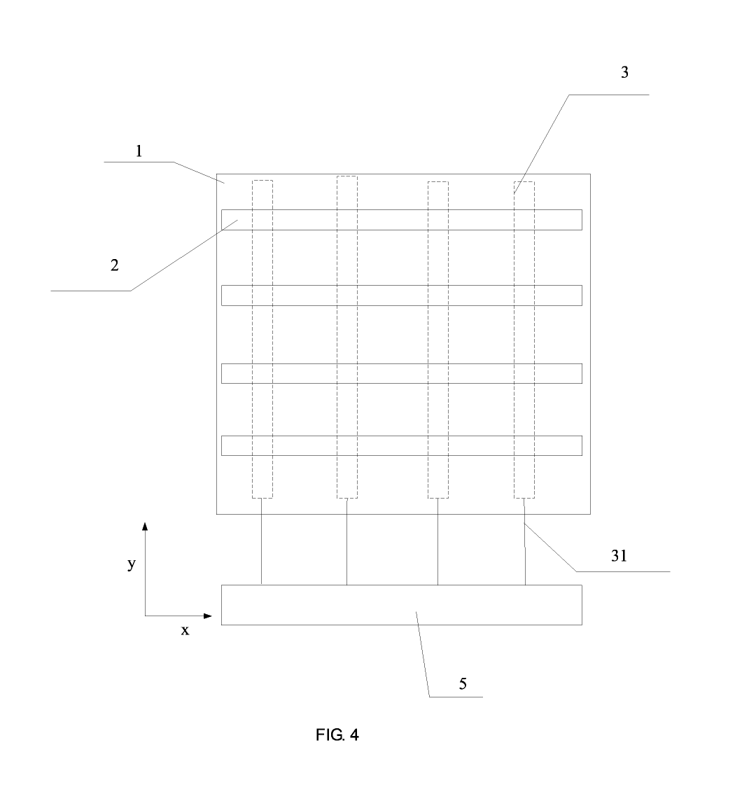

As shown in FIG. 4, the plurality of first touch sub-units 2 are formed on the first insulating layer through a patterning process, and the first touch sub-units 2 may be transverse touch sub-units.

S4, forming a second insulating layer.

Specifically, the second insulating layer may be formed by depositing silicon dioxide, silicon nitride, or silicon oxynitride, or by coating a transparent and insulating resin. Specifically, plasma vapor deposition or physical sputtering deposition may be employed.

S5, forming a plurality of via holes 4 in the second insulating layer through a patterning process.

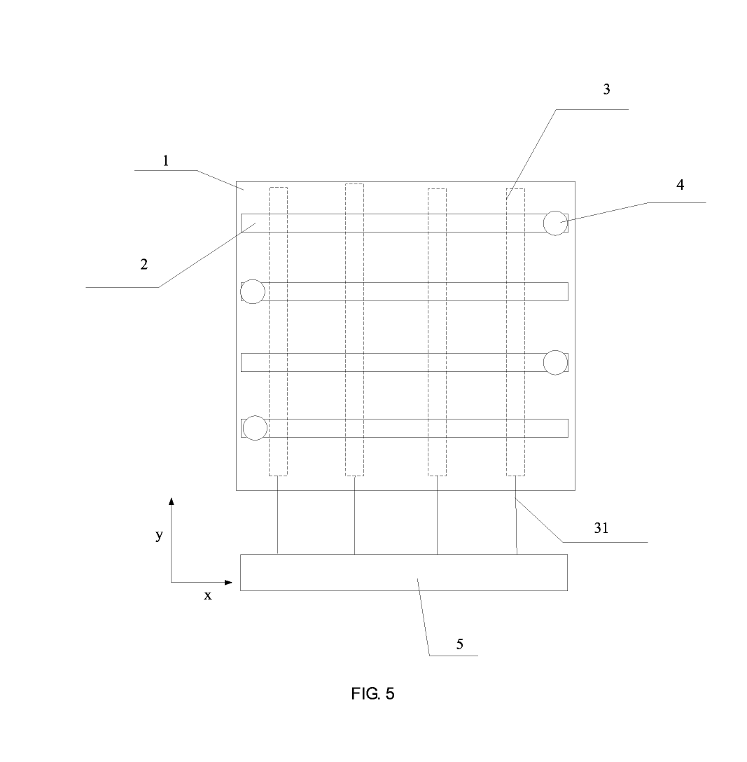

Specifically, as shown in FIG. 5, via holes 4 are formed at positions of the second insulating layer corresponding to ends of the transverse touch sub-units. In this embodiment, positions of via holes for any two adjacent transverse touch sub-units correspond to ends of the two adjacent transverse touch sub-units at different sides, but the present invention is not limited thereto.

S6, forming a plurality of first leads 21 within an active area 1, the plurality of first leads 21 being respectively connected with the plurality of first touch sub-units 2 through the plurality of via holes 4.

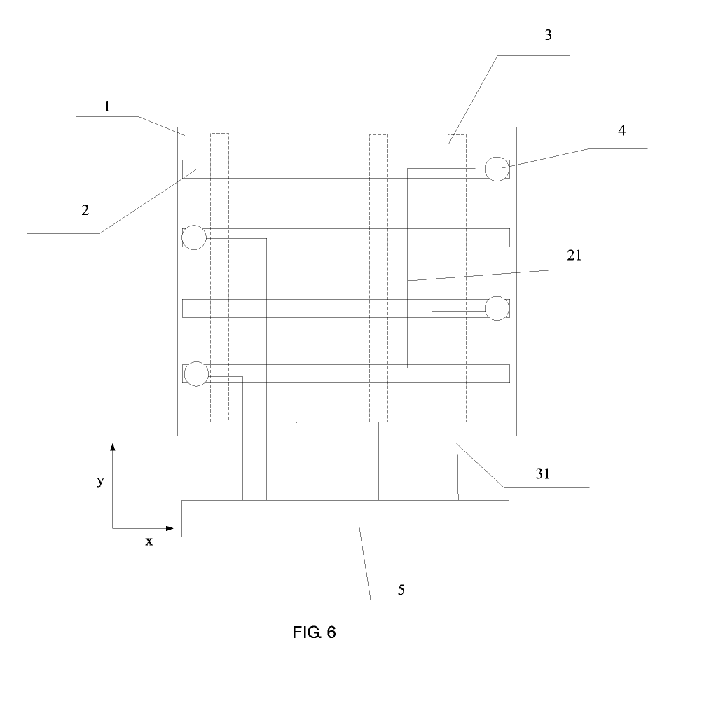

As shown in FIG. 6, one end of the first lead 21 is connected to the transverse touch sub-unit through via hole 4, and the other end thereof is connected to the bonding area 5.

Subsequently, other necessary function layers are formed, so as to form the touch substrate.

### Embodiment 3

The present embodiment provides a touch display panel, including the above touch substrate.

It could be understood that, above embodiments, in which the plurality of first leads connecting with the plurality of transverse touch sub-units are provided within the active area, have been taken as examples, but the present invention is not limited thereto. According to the position of the bonding area, the plurality of second leads connecting with the plurality of longitudinal touch sub-units may be provided within the active area. In this case, the manufacturing process of the touch substrate should be adjusted correspondingly.

It could be understood that the foregoing implementations are merely exemplary implementations for purpose of explaining the principle of the present invention, but the present invention is not limited thereto. Various modifications and improvements can be made for those skilled in the art without departing from the spirit and essence of the present invention, and these modifications and improvements shall also fall within the protection scope of the present invention.

What is claimed is:

1. A touch substrate, including a touch unit, which includes a plurality of first touch sub-units and a plurality of second touch sub-units both provided within an active area, wherein
the plurality of first touch sub-units and the plurality of second touch sub-units are electrically connected to a bonding area located outside the active area, through a plurality of first leads and a plurality of second leads, respectively; and
the plurality of first leads or the plurality of second leads are provided within the active area.

2. The touch substrate according to claim 1, wherein
the plurality of second touch sub-units are a plurality of longitudinal touch sub-units, and the plurality of longitudinal touch sub-units are respectively connected to the plurality of second leads provided at the same side thereof; and
the plurality of first touch sub-units are a plurality of transverse touch sub-units, and the plurality of transverse touch sub-units are respectively connected to the plurality of first leads within the active area through via holes.

3. The touch substrate according to claim 2, wherein positions of via holes for any two adjacent transverse touch sub-units correspond to ends of the two adjacent transverse touch sub-units at different sides.

4. The touch substrate according to claim 2, wherein an insulating layer is provided between the first leads and the touch unit.

5. The touch substrate according to claim 4, wherein the insulating layer is made of silicon dioxide, silicon nitride, silicon oxynitride, or a transparent and insulating resin.

6. The touch substrate according to claim 4, wherein the via holes are provided in the insulating layer.

7. The touch substrate according to claim 1, wherein the first or second leads provided within the active area are made of a transparent and conductive material.

8. The touch substrate according to claim 7, wherein the first or second leads provided within the active area are made of indium tin oxide.

9. The touch substrate according to claim 1, wherein the first or second leads provided within the active area are of a transparent composite structure having an anti-reflective coating.

10. A manufacturing method of a touch substrate, including steps of:
forming a plurality of second touch sub-units and a plurality of second leads located at the same side of the respective second touch sub-units on a base through a patterning process;
forming a first insulating layer;
forming a plurality of first touch sub-units on the first insulating layer through a patterning process;
forming a second insulating layer;
forming a plurality of via holes in the second insulating layer through a patterning process; and
forming a plurality of first leads within an active area, the plurality of first leads being respectively connected with the plurality of first touch sub-units through the plurality of via holes.

11. A touch display panel, including a touch substrate, the touch substrate including a touch unit, which includes a plurality of first touch sub-units and a plurality of second touch sub-units both provided within an active area, wherein
the plurality of first touch sub-units and the plurality of second touch sub-units are electrically connected to a bonding area located outside the active area, through a plurality of first leads and a plurality of second leads, respectively; and
the plurality of first leads or the plurality of second leads are provided within the active area.

12. The touch display panel according to claim 11, wherein
the plurality of second touch sub-units are a plurality of longitudinal touch sub-units, and the plurality of longitudinal touch sub-units are respectively connected to the plurality of second leads provided at the same side thereof; and
the plurality of first touch sub-units are a plurality of transverse touch sub-units, and the plurality of transverse touch sub-units are respectively connected to the plurality of first leads within the active area through via holes.

13. The touch display panel according to claim 12, wherein positions of via holes for any two adjacent transverse touch sub-units correspond to ends of the two adjacent transverse touch sub-units at different sides.

14. The touch display panel according to claim 12, wherein an insulating layer is provided between the first leads and the touch unit.

15. The touch display panel according to claim 14, wherein the insulating layer is made of silicon dioxide, silicon nitride, silicon oxynitride, or a transparent and insulating resin.

16. The touch display panel according to claim 14, wherein the via holes are provided in the insulating layer.

17. The touch display panel according to claim 11, wherein the first or second leads provided within the active area are made of a transparent and conductive material.

18. The touch display panel according to claim 17, wherein the first or second leads provided within the active area are made of indium tin oxide.

19. The touch display panel according to claim 11, wherein the first or second leads provided within the active area are of a transparent composite structure having an anti-reflective coating.
